(19) United States
(12) Patent Application Publication
(10) Pub. No.: US 2004/0140272 A1
(43) Pub. Date: Jul. 22, 2004

(54) System and method for material removal

(76) Inventors: Susan Litherland, Austin, TX (US); Allen Whitley, Austin, TX (US); Rene Aguilar, Austin, TX (US)

Correspondence Address: Joan T. Kluger, IP Department, Schnader Harrison Segal & Lewis LLP, 1600 Market Street, Suite 3600, Philadelphia, PA, 19103, US

(21) Appl. No.: 10/672,368

(22) Filed: Sep. 26, 2003

Related U.S. Application Data
(60) Provisional application No. 60/414,034, filed on Sep. 27, 2002.

(51) Int. Cl. C02F 1/40

(52) U.S. Cl. 210/776; 210/122; 210/242.3

(57) ABSTRACT

A material recovery system having a float that has a specific gravity less than material not being removed but greater than material being removed, allowing the float to remain at the interface of the materials. A tube is attached to the float so it only penetrates material being removed. An outlet end portion of the tube is attached to an inlet of a pump. When the pump is actuated the material being removed is extracted through the tube, leaving other materials behind. A windmill may be used to power the remediation system. Also disclosed is a sliding stroke reducer to adjust windmill stroke length.

### PRIOR APPLICATION

This application is based on provisional application having serial No. 60/414,034, and a filing date of Sep. 27, 2002, entitled, “System and Method for Material Removal.

### FIELD OF THE INVENTION

This invention relates to a system and method for material removal, particularly applicable to environmental remediation.

### BACKGROUND

Recovery of phase-separated hydrocarbons (PSH), such as oil or gasoline, is a common problem in the field of environmental remediation. As used herein, “phase-separated hydrocarbons” means hydrocarbons (petroleum refined and by-products) that do not dissolve significantly in water. These contaminants may find their way into the environment through pipeline leaks and ruptures, storage tank leaks and other similar pathways.

PSHs can be recovered by a number of different methods. Method options for recovery at remote sites, however, are limited, and those available are often difficult and expensive to implement. A remote site may have any of the following characteristics: 1) it is not easily accessible by conventional means such as by car or truck, 2) it does not have a readily available supply of power, such as, air or electrical, or 3) it does not impact populated areas. Remote sites can present similar liability issues to accessible sites, particularly because of contaminant migration. Maintenance and oversight expenses at remote sites can substantially increase the cost of a traditional recovery method. Furthermore, recovery at both remote and accessible sites can be very costly given the long duration that recovery operations sometimes run.

The composition of fluids recovered during PSH-recovery may also be problematic. Some remediation schemes recover not only the PSH but also a substantial quantity of water or other non-contaminant that must then be disposed of or treated. Remediation of contaminants other than PSH can pose similar problems when present in material mixtures. Post-recovery processes implemented to deal with such problems can add significant costs to the overall recovery efforts.

Thus, a need exists for a selective-constituent recovery method that, even if long in duration, can be implemented at relatively low-cost.

### SUMMARY OF THE INVENTION

The invention provides material remediation system that, in a preferred embodiment, may be readily used for applications in remote locations. The invention is particularly applicable to the recovery of phase-separated hydrocarbons in a selective-constituent manner.

Embodiments of the invention use a windmill as a power source to facilitate remediation at locations that may be difficult to access. The material recovery system has a float that has a specific gravity less than material not being removed but greater than material being removed, allowing the float to remain at the interface of the materials. A tube is attached to the float so it only penetrates material being removed. An outlet end portion of the tube is attached to an inlet of a pump. When the pump is actuated the material being removed is extracted through the tube, leaving other materials behind.

The invention further includes a sliding stroke reducer to adjust windmill stroke length.

### DESCRIPTION OF THE DRAWINGS

The invention is best understood from the following description when read with the accompanying drawings.

FIG. 1 depicts a recovery system according to an illustrative embodiment of the invention.

FIGS. 2A-B depict a recovery system according to an illustrative embodiment of the invention.

FIG. 3 depicts a recovery system according to an illustrative embodiment of the invention.

FIGS. 4A-C depict a sliding stroke reducer according to an illustrative embodiment of the invention.

### DETAILED DESCRIPTION OF THE INVENTION

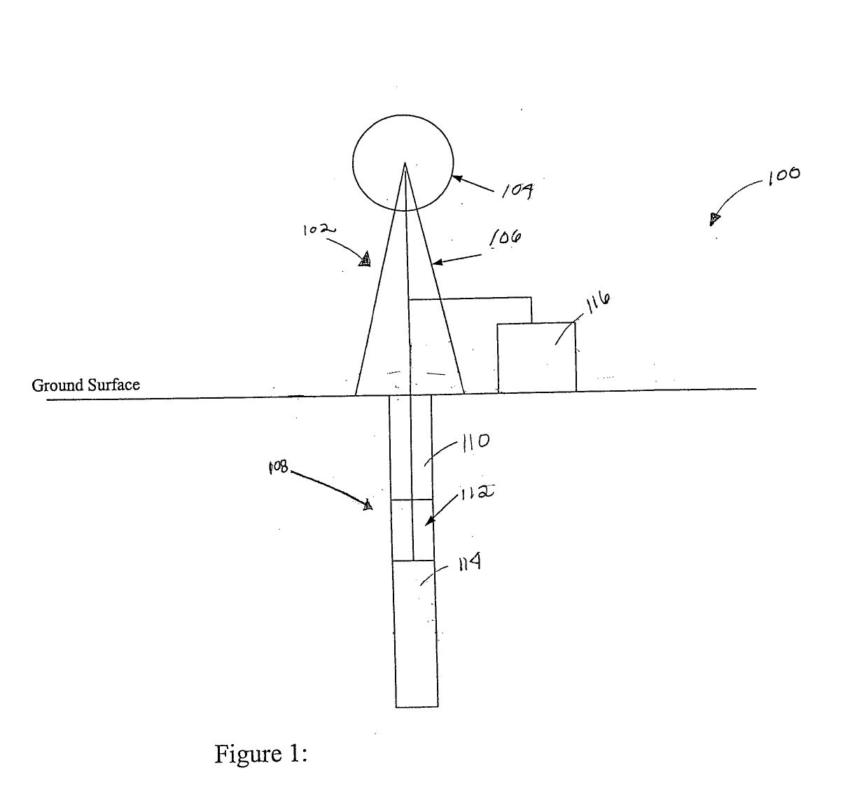

FIG. 1 depicts a material recovery system 100 according to an illustrative embodiment of the invention. Aboveground equipment 102 may consist of a windmill 104 or wind turbine and stub tower 106. The sizing of the windmill is dependent upon required recovery rates and depth to material to be recovered. Conventional windmills may be used without modifications to accommodate the new application. Modifications, however, may be desirable, for example to windmill size and stroke length, depending on the application and site. The main purpose of the windmill is to provide power to the system and actuate the pump using available winds. This is similar to its function in a water-well application. Use of a windmill facilitates recovery at remote sites. The invention, however, may be implemented using other power sources. Aboveground equipment may also include a recovery tank 116 to collect recovered materials.

Belowground components 108 include a well 110 into which at least two materials of differing specific gravity may enter. The exemplary embodiment depicted in FIG. 1 shows well 110 containing material 112 having a specific gravity less than that of material 114.

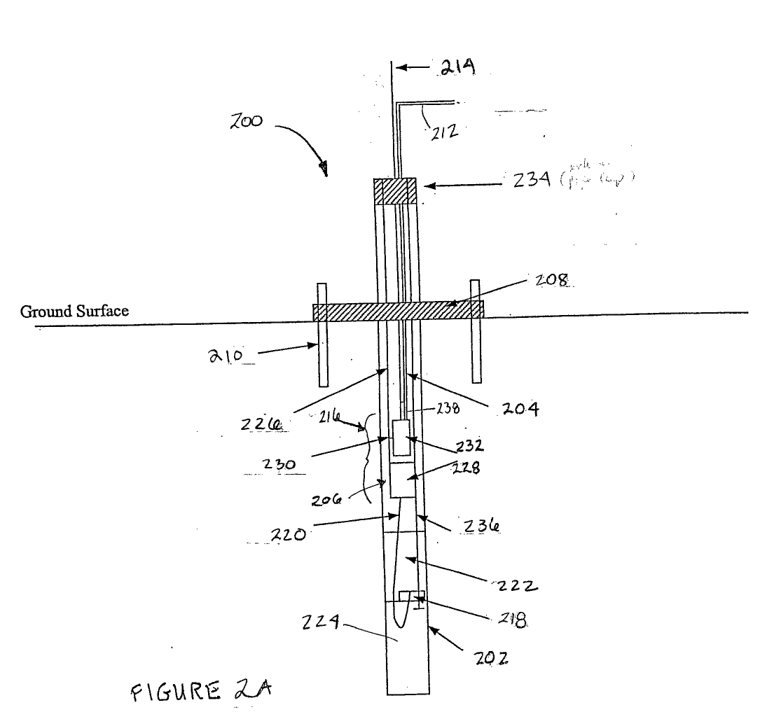

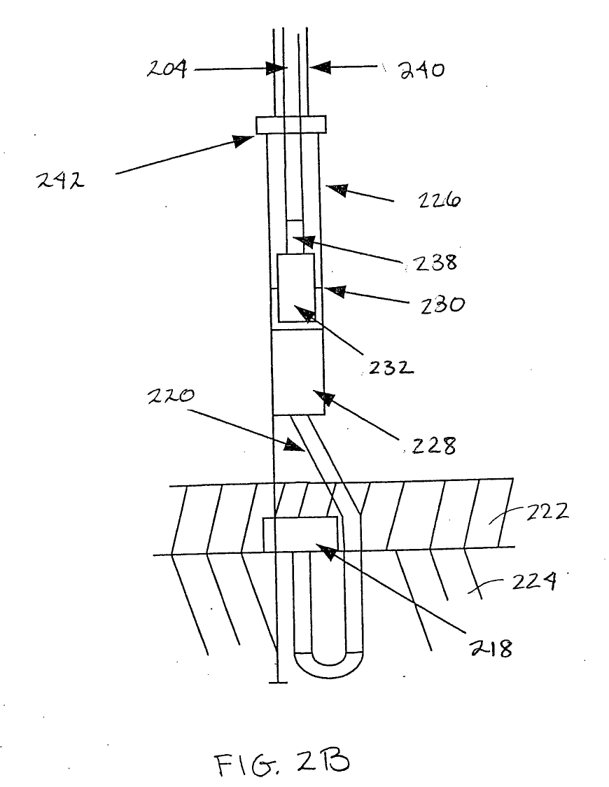

FIG. 2A depicts a more detailed rendition of an illustrative embodiment of the invention. Further detail is shown in FIG. 2B. Recovery system 200 is used to remove a first material 222 from a well 206. A second material 224 is also present in well 206, but does not need to be removed, and preferably remains in well 206 during the removal process. As used herein, “material” may include one or more materials.

Recovery system 200 includes a well casing 202 preferably positioned vertically into the ground and preferably partially aboveground. Well casing 202 provides walls for well 206. Exterior pipe 226 is disposed within well casing 202, and preferably extends a distance above the top of well casing 202. Exterior pipe 226 houses a pump 216 for pumping material from well 206. Pump 216 is functionally connected to pump rod 214 which is attached to a windmill, or other power source. It is also possible for the system to be designed to be pumped manually. Transport pipe 204 is disposed within well casing 202. Material being removed can be transported through pipe 204. Pipe 204 may be intergral with conduit 212 or may comprise separate pieces.

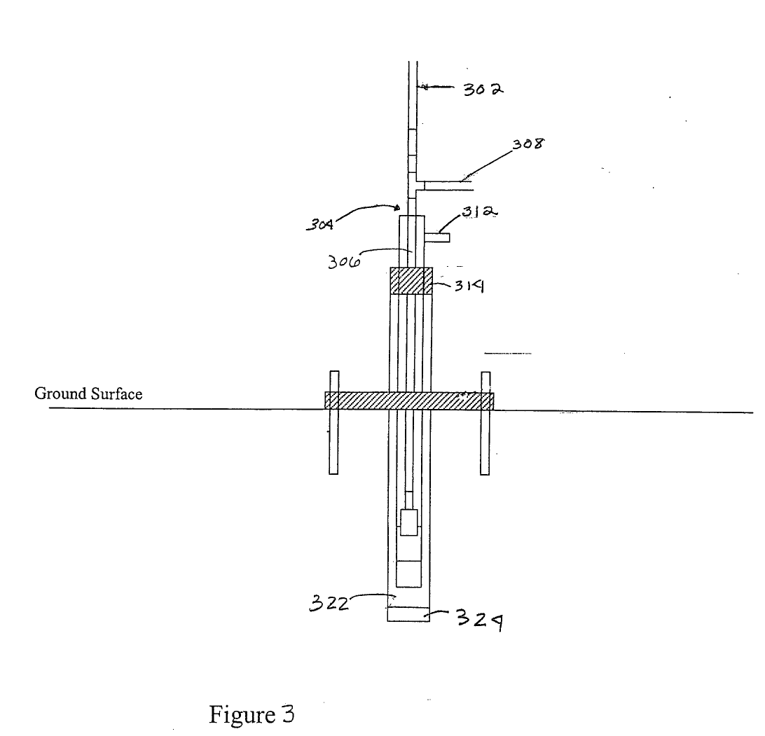

FIG. 2A shows a separate pump rod 214, however, transport pipe or tubing 204 may also act as a pump rod, negating the need for rod 214. FIG. 3 depicts an embodiment wherein the transport pipe and the pump rod are one in the same. This will be described in more detail below.

The embodiment depicted in FIG. 2B, shows a bushing 242 at the interface of exterior pipe 226 and, a smaller diameter pipe 240.

Transport pipe 204 and well casing 202 may be disposed through a support pad 208 to stabilize or secure the recovery system. Support pad 208 is preferably constructed of concrete. Support pad 208 may be anchored to the ground, for example by anchors 210.

Conduit 212 carries recovered material to a tank (not shown) or other containment structure. Below ground components include pump 216, used to remove first material 222 from well 206. Pump 216 is attached to a float 218 by tubing 220. Also attached to float 218 is a float rod 236. Tubing 220 is preferably flexible to accommodate movement of the float and pipe. Float 218 has a higher density than first material 222, so it sinks on first material 222. Second material 224 has a higher density than both first material 222 and float 218. Therefore, float 218 and first material 222 can float on second material 224, thereby facilitating removal of only first material 222, as will be described in more detail by the following example. In general, float 218 should be less dense than the lightest material not being removed and more dense than the densest material being removed so float 218 is positioned at the interface of these two materials.

In a preferred embodiment, only when first material 222 reaches a certain thickness, will it flow into an intake port or hole in float 218 to be pumped out. Preferably the threshold thickness is approximately 0.5 inches. Illustrative threshold thickness ranges are 0.25 inches to 0.75 inches, and 0.4 inches to 0.6 inches.

To recover first material 222, tubing 220 may be inserted through a hole in float 218. Tubing 220 is preferably inserted through the bottom of float 218 so that it only removes first material 222 and little or no amount of material 224. The outlet end of tubing 220 is attached to the inlet of pump 216. As pump 216 is activated by a power source or manually, first material 222 is extracted through tubing 220. As first material 222 enters pump 216 it is displaced through a section of pipe 204 attached to the top of pump 216, and eventually gravity drains at the top of well 206. Material 222 can then be directed to a holding tank, or other container.

In an illustrative embodiment, float 218 is high-density polyethylene (HDPE), first material 222 is a PSH and second material 224 is water. A float made of HDPE floats on water but not on a PSH. Therefore, tubing 220, which is attached to float 218, does not have an end in the water. This enables a user to remove the PSH through tubing 220 without also removing the water. The invention is particularly suitable for recovery of hydrocarbons that are of lower density than water, and therefore, float on water. However, substances other than hydrocarbons can be removed from surrounding materials according to embodiments of the invention.

A significant advantage of the invention is that the float can be situated such that filters or selective membranes are not necessary, which can become clogged or ineffective over time.

A further advantage of embodiments of the invention is the ability to use an HDPE, or similar material, float. While other types of float materials exist and can be used, HDPE's specific gravity, durability, machinability, and resistance to PSHs are unique and make it a particularly suitable choice to provide access to only the PSH in the well. The material chosen may depend, for example, on the environment in which it is used and the specific gravity of the removed and surrounding materials. Buoyancy of the float in a particular environment may be adjusted, for example, by drilling one or more holes in the float and plugging them to create air spaces within the material, or by adding denser material.

Advantageously, this technology can utilize a conventional power system such as a windmill or peristaltic pump. The invention, however, is not limited to use with windmills, but may be used with other conventional power systems, or power systems modified for use with the invention. Any power source compatible with the material removal system is within the scope of the invention.

One advantage of using a windmill or peristaltic pump is that they can run continuously but are generally not damaged by running “dry”. If there is material being removed, the material is pumped, if there is no material, then air is pumped. This minimizes the amount of material being removed that does not necessarily need removal, such as water. This can be cost effective because material removed unnecessarily typically requires some form of treatment.

The invention further includes a well pump having a unique configuration. Conventional well pumps have a pump rod to operate a check valve, and an exterior pipe to carry away material pumped from the well. In a preferred embodiment of the present invention, the transport pipe acts as both a pump rod and a transport pipe.

FIG. 3 depicts an exemplary embodiment of the invention wherein the transport pipe also serves as the pump rod. In this illustration, material 324 preferably remains in the well while material 322 is removed. A windmill or other power source can be attached to an upper portion 302 or pipe 304. A lower portion 306 of pipe 304 can transport material being removed. A conduit 308 attached to pipe 304 can carry material to a containment object. An over flow tube 312 can be included to provide for release of excessive material accumulating in the system. A pipe cap 314 may also be included to seal the system.

Returning to FIGS. 2A-B, operation of the pump is described. On the upstroke, an interior check valve 228 closes and material 222 is moved through tube 220 into a lower chamber of pump 216. On the downstroke, an exterior check valve 238 closes and material 222 in the lower pump chamber is forced into and up transport pipe 204. It can then gravity drain into a tank at the surface. O-ring 230 provides a seal around plunger 232. A channel may be cut into plunger 232 to accommodate o-ring 230. O-ring 230 should withstand materials to which it is exposed, such as PSHs. It is also advisable for o-ring 230 to be able to withstand pressures of 14-20 psi.

The invention further includes a sliding stroke reducer to adjust windmill stroke length. Windmills typically have two settings, a short and a long stroke, for example, a short stroke of 3.75″ and a long stroke of 5″. The strokes vary depending upon the size of the windmill. In an application such as described herein, a conventional short stroke length may be too long because a longer stroke places more stress on the moving parts of the windmill, pump, and piping. The sliding stroke reducer may provide particular stroke lengths needed for various applications. By using the sliding stroke reducer, the length of the windmill's stroke can easily be adjusted, for example from a full stroke to a half stroke. This may considerably reduce stress on the windmill, especially in high winds, and may extend the life of the components.

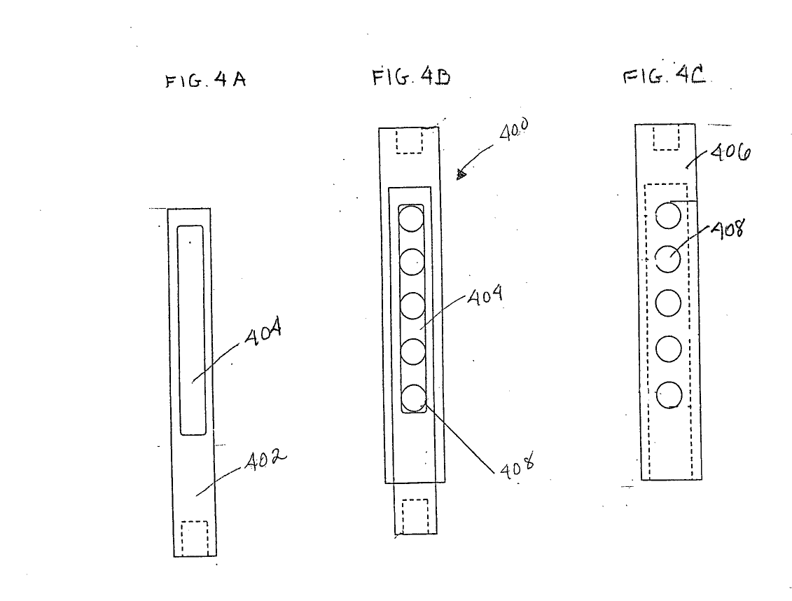

FIGS. 4A-C depict components of a sliding stroke reducer, according to an illustrative embodiment of the invention. FIG. 4A depicts a first reducer component 402 having a slot 404 therein. An illustrative length range for component 402 is about 5.5 inches to about 8.5 inches, with an exemplary length of about 7.0 inches. An illustrative slot length range is about 3.25 inches to about 4.25 inches with an exemplary length of about 3.75 inches. FIG. 4C depicts a second reducer component 406 having a plurality of openings 408. In an illustrative embodiment, component 406 has a length in the range of about 8 inches to about 11 inches, with a preferred length of about 9 inches. Openings 408 preferably have a diameter in the range of about 6/32 inch to about 12/32 inch, with a diameter most preferably being 9/32 inch. The width of slot 404 is preferably of a diameter similar to that of openings 408. Openings 408 preferably are spaced apart from center point to center point in the range of about ¾ inch to about 1.0 inch, and most preferably about ⅞ inch. The width of components 402 and 406 are preferably in the range of about 1.0 inch to about 1.3 inches and are most preferably about 1.125 inches.

Reducer components 402 and 406 fit together to form sliding stroke reducer 400 as shown in FIG. 4B. First reducer component 402 is in functional cooperation with second reducer component 406 so that at least one opening 408 is aligned with slot 404 such that a locking element such as a pin or similar device may be inserted through opening 408 and slot 404 to limit the movement of sliding stroke reducer 400, thereby locking it into a desired position and reducing the length of the windmill stroke. This allows simple adjustments of windmill stroke length by simply removing and reinserting one or more locking pins.

The material remediation systems and methods may also include sensors to sensor progress of the remediation system or environmental conditions. These sensors can be monitored remotely, for example by using a PC or laptop computer to further support remote location remediation. Remotely operated switches may also be incorporated into the system.

While the invention is described by illustrative embodiments, additional advantages and modifications will occur to those skilled in the art. Therefore, the invention in its broader aspects is not limited to specific details shown and described herein. Modifications may be made without departing from the spirit and scope of the invention, for example to materials, and system configurations and components. Accordingly, it is intended that the invention not be limited to the specific illustrative embodiments, but be interpreted within the full spirit and scope of the claims and their equivalents.

Claimed is:

1. A material remediation system used with a pump having a material inlet and a material outlet, the system comprising:
a float having a specific gravity less than material not being removed but greater than material being removed; and
a tube having an outlet end portion and an inlet end portion, the outlet end portion operatively connected to the material inlet of the pump, and the inlet end portion operatively connected to the float so that substantially only material being removed can enter the inlet end portion;
wherein the material being removed is pumped through the tube and the pump, and is discharged through the material outlet.

2. The material remediation system of claim 1 further comprising a means for providing power to the system.

3. The material remediation system of claim 2 wherein the means for providing power to the system is a windmill.

4. The material remediation system of claim 2 wherein the means for providing power to the system is a peristaltic pump.

5. The material remediation system of claim 1 further comprising a tank into which removed material is directed.

6. The material remediation system of claim 1 wherein the material being removed is a hydrocarbon.

7. The material remediation system of claim 1 wherein the float comprises HDPE.

8. The material remediation system of claim 3 wherein, the windmill has a sliding stroke reducer, wherein the stroke reducer comprises:
a first reducer component having an elongated shape with a longitudinally-disposed slot therein; and
a second reducer component having a plurality of openings therein;
wherein the first reducer component is in functional cooperation with the second reducer component so that the slot can be aligned with at least one second reducer component opening so that upon insertion of a pin in the at least one opening locks the first reducer component in place with respect to the second reducer component.

9. The material remediation system of claim 1 further comprising a transport pipe to transport removed material out of the system.

10. The material remediation system of claim 9 wherein the transport pipe also functions as a pump rod.

11. The material remediation system of claim 1 wherein the material being removed is only pumped through the tube and pump when it reaches a predetermined thickness.

12. The material remediation system of claim 11 wherein the predetermined thickness is in the range of about 0.25 inches to about 0.75 inches.

13. The material remediation system of claim 1 further comprising one or more sensors to monitor the system and/or environmental parameters.

14. The material remediation system of claim 13 wherein at least one of the one or more sensors is monitored remotely.

15. The material remediation system of claim 1 further comprising one or more remotely operated switches.

16. A method of material remediation comprising:
positioning a float in a layer of material to be removed wherein the layer of material being removed is floating on top of a layer of material not being removed;
attaching a tube to the float so it only penetrates material being removed;
attaching an outlet end portion of the tube to an inlet of a pump; and
actuating the pump to extract the material being removed through the tube;
wherein the float is made of a material having a specific gravity less than material not being removed but greater than material being removed.

17. The method of claim 16 further comprising:
gravity draining the material being removed to a tank.

18. The method of claim 16 further comprising providing power to actuate the pump with a windmill or peristaltic pump.

19. The method of claim 16 wherein the material being removed is a hydrocarbon.

20. The method of claim 16 wherein the material is only extracted when it reached a predetermined thickness.

21. The method of claim 20 wherein the predetermined thickness is in the range of about 0.25 inches to about 0.75 inches.

22. A sliding stroke reducer comprising:
a first reducer component having an elongated shape with a longitudinally-disposed slot therein; and
a second reducer component having a plurality of openings therein;
wherein the first reducer component is in functional cooperation with the second reducer component so that the slot can be aligned with at least one second reducer component opening so that upon insertion of a locking element in the at least one opening locks the first reducer component in place with respect to the second reducer component.

23. A windmill comprising a sliding stroke reducer according to claim 22.
